(19) United States
(12) Patent Application Publication
(10) Pub. No.: US 2003/0126171 A1
(43) Pub. Date: Jul. 3, 2003

(54) Temporal order independent numerical computations

(76) Inventors: Yan Hou, Folsom, CA (US); Kam Leung, El Dorado Hills, CA (US)

Correspondence Address: KENYON & KENYON, ONE BROADWAY, NEW YORK, NY, 10004, US

(21) Appl. No.: 10/017,240

(22) Filed: Dec. 13, 2001

(51) Int. Cl. G06F 17/14

(52) U.S. Cl. 708/402

(57) ABSTRACT

A method and system for processing data arriving from a bit-stream to perform numerical computations in a temporal order independent fashion. According to one embodiment, the method is applied to IDCT computations to allow processing of IDCT coefficients in the same order they are received from an MPEG bit stream. The coefficients are not required to be converted from scan order to array order before processing. This provides significant advantages in that it imposes minimal storage requirements for the coefficients and the coefficients are processed in scan order.

### FIELD OF THE INVENTION

The present invention relates to the areas of computation and algorithms and specifically to the areas of digital signal processing (“DSP”) and digital logic for performing DSP operations to the areas of digital signal processing, algorithms, structures and systems for performing digital signal processing. In particular, the present invention relates to a system and method for performing temporal order independent numerical computations.

### BACKGROUND INFORMATION

Digital signal processing (“DSP”) and information theory technology is essential to modern information processing and in telecommunications for both the efficient storage and transmission of data. In particular, effective multimedia communications including speech, audio and video relies on efficient methods and structures for compression of the multimedia data in order to conserve bandwidth on the transmission channel as well as to conserve storage requirements.

Many DSP algorithms rely on transform kernels such as an FFT (“Fast Fourier Transform”), DCT (“Discrete Cosine Transform”), etc. For example, the discrete cosine transform (“DCT”) has become a very widely used component in performing compression of multimedia information, in particular video information. The DCT is a loss-less mathematical transformation that converts a spatial or time representation of a signal into a frequency representation. The DCT offers attractive properties for converting between spatial/time domain and frequency representations of signals as opposed to other transforms such as the DFT (“Discrete Fourier Transform”)/FFT. In particular, the kernel of the transform is real, reducing the complexity of processor calculations that must be performed. In addition, a significant advantage of the DCT for compression is that it exhibits an energy compaction property, wherein the signal energy in the transform domain is concentrated in low frequency components, while higher frequency components are typically much smaller in magnitude, and may often be discarded. The DCT is in fact asymptotic to the statistically optimal Karhunen-Loeve transform (“KLT”) for Markov signals of all orders. Since its introduction in 1974, the DCT has been used in many applications such as filtering, transmultiplexers, speech coding, image coding (still frame, video and image storage), pattern recognition, image enhancement and SAR/IR image coding. The DCT has played an important role in commercial applications involving DSP, most notably it has been adopted by MPEG (“Motion Picture Experts Group”) for use in MPEG 2 and MPEG 4 video compression algorithms.

A computation that is common in digital filters such as finite impulse response (“FIR”) filters or linear transformations such as the DFT and DCT may be expressed mathematically by the following dot-product equation:

$$d = {\sum }_{i = 0}^{N - 1} a ( i ) * b ( i )$$

where a(i) are the input data, b(i) are the filter coefficients (taps) and d is the output. Typically a multiply-accumulator (“MAC”) is employed in traditional DSP design in order to accelerate this type of computation. A MAC kernel can be described by the following equation:

d^{[i+1]}=d^{[i]}+a(i)*b(i) with initial value d^{[0]}=0.

In many cases, however, data coefficients may arrive in a temporal order that introduces pipeline stalls at the filter/transformation block of the circuit. Pipeline stalls are introduced because the operation of the circuit is designed based upon multiply and accumulate equations that require particular data to be present in order to carry out the computation.

For example, in the 1-D IDCT vertical transformation, the IDCT coefficients arrive serially from an MPEG video stream in scan order. In order to perform the 1-D vertical IDCT operation based upon the underlying formulae, a column of coefficients must be available before the operation can be performed for that column. With traditional approaches, the coefficients arriving serially from the bit stream must be stored in memory (e.g., SRAM (“Static Random Access Memory”)) until the whole column or row is available. For example, in zig-zag scan order up to 35 coefficients must be stored before an operation can start even though only 8 coefficients are needed. A significant disadvantage of this approach is that it prevents efficient implementation of a pipeline operation due to the “wait-and-then process,” which inserts bubbles into the pipeline.

### BRIEF DESCRIPTION OF THE DRAWINGS

FIG. 1a is a block diagram of a video encoding system.

FIG. 1b is a block diagram of a video decoding system.

FIG. 2 is a block diagram of a datapath for computing a 2-D IDCT.

FIG. 3 is a block diagram illustrating the operation of a MAC kernel.

FIG. 4 is a block diagram illustrating the operation of a MAAC kernel according to one embodiment of the present invention.

FIG. 5 illustrates a paradigm for improving computational processes utilizing a MAAC kernel according to one embodiment of the present invention.

FIG. 6 is a block diagram of a hardware architecture for computing an eight point IDCT utilizing a MAAC kernel according to one embodiment of the present invention.

FIG. 7 is a block diagram illustrating a system for performing temporal order independent numerical computations on data.

FIG. 8a illustrates a zig-zag scan order for 2-D DCT coefficients.

FIG. 8b illustrates an alternate horizontal scan order for 2-D coefficients.

FIG. 9 is a block diagram of a system for temporal order independent computation of a 2-D IDCT according to one embodiment of the present invention.

FIG. 10 illustrates a buffer block, IDCT computation unit and TRAM unit for computation of an eight-point IDCT according to one embodiment of the present invention.

FIG. 11 illustrates FIG. 10 illustrates a state of a buffer block, IDCT computation unit and TRAM unit for computation of an eight-point IDCT exemplary scenario for the computation of a 1-D 8 point IDCT, wherein the DCT coefficients arrive in zig-zag scan order.

FIG. 12a illustrates a state of a buffer block with respect to an IDCT computation unit and TRAM during a first clock cycle according to one embodiment of the present invention.

FIG. 12b illustrates a state of a buffer block with respect to an IDCT computation unit and TRAM during a second clock cycle according to one embodiment of the present invention.

FIG. 12c illustrates a state of a buffer block with respect to an IDCT computation unit and TRAM during a third clock cycle according to one embodiment of the present invention.

FIG. 12d illustrates a state of a buffer block with respect to an IDCT computation unit and TRAM during a fourth clock cycle according to one embodiment of the present invention.

FIG. 12e illustrates a state of a buffer block with respect to an IDCT computation unit and TRAM during a fifth clock cycle according to one embodiment of the present invention.

FIG. 13 illustrates a hardware embodiment for computing an 8-point IDCT according to one embodiment of the present invention.

### DETAILED DESCRIPTION

The present invention relates to a method and system for processing data arriving from a bit-stream to perform numerical computations in a temporal order independent fashion. According to one embodiment, the present invention is applied to IDCT computations to allow processing of IDCT coefficients in the same order they are received from an MPEG bit stream. The coefficients are not required to be converted from scan order to array order before processing. This provides significant advantages in that it imposes minimal storage requirements for the coefficients and the coefficients are processed in scan order.

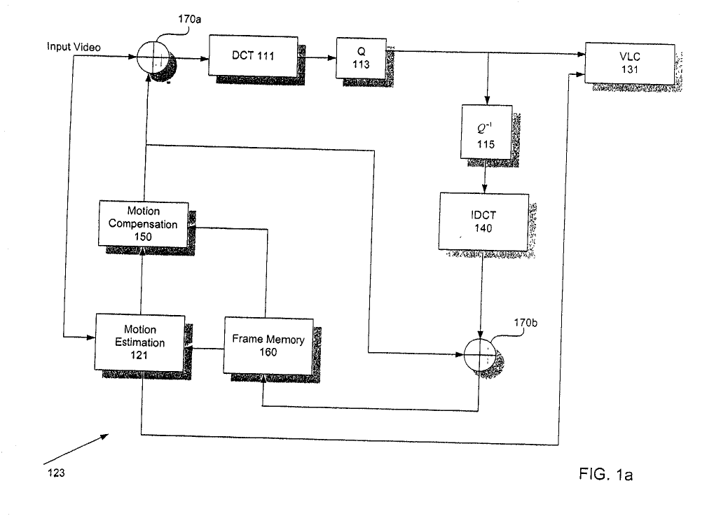

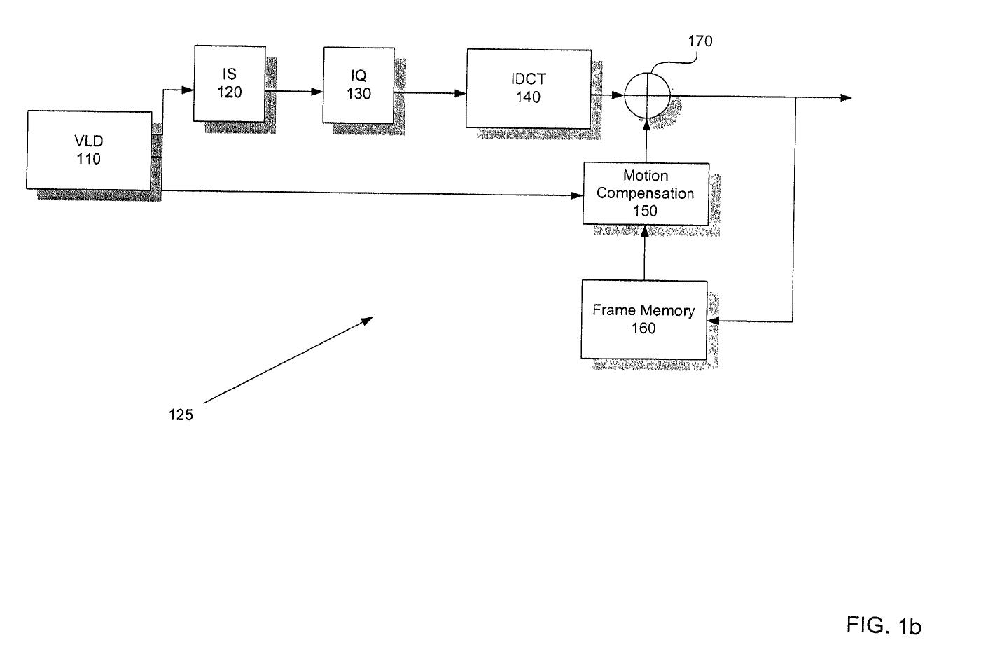

FIG. 1a is a block diagram of a video encoding system. Video encoding system 123 includes DCT block 111, quantization block 113, inverse quantization block 115, IDCT block 140, motion compensation block 150, frame memory block 160, motion estimation block and VLC (“Variable Length Coder”) block 131. Input video is received in digitized form. Together with one or more reference video data from frame memory, input video is provided to motion estimation block 121, where a motion estimation process is performed. The output of motion estimation block 121 containing motion information such as motion vectors is transferred to motion compensation block 150 and VLC block 131. Using motion vectors and one or many reference video data, motion compensation block 150 performs motion compensation process to generate motion prediction results. Input video is subtracted at adder 170a by the motion prediction results from motion compensation block 150.

The output of adder is provided to DCT block 111 where a DCT computed. The output of the DCT is provided to quantization block 113, where the frequency coefficients are quantized and then transmitted to VLC (“Variable Length Coder”) 131, where a variable length coding process (e.g., Huffman coding) is performed. Motion information from motion estimation block 121 and quantized indices of DCT coefficients from Q block 113 are provided to VLC block 131. The output of VLC block 131 is the compressed video data output from video encoder 123 The output of quantities block 113 is also transmitted to inverse quantization block 115, where an inverse quantization process is performed.

The output of inverse quantization block is provided to IDCT block 140, where IDCT is performed. The output of IDCT block is summered at adder 107(b) with motion prediction results from motion compensation. The output of adder 170b is reconstructed video data and is stored in the frame memory block 160 to serve as reference data for the encoding of future video data.

FIG. 1b is a block diagram of a video decoding system. Video decoding system 125 includes variable length decoder (“VLD”) block 110, inverse scan (“IS”) block 120, inverse quantization block (“IQ”) 130, IDCT block 140, frame memory block 160, motion compensation block 150 and adder 170. A compressed video bitstream is received by VLD block and decoded. The decoded symbols are converted into quantized indices of DCT coefficients and their associated sequential locations in a particular scanning order. The sequential locations are then converted into frequency-domain locations by the IS block 120. The quantized indices of DCT coefficients are converted to DCT coefficients by the IQ block 130. The DCT coefficients are received by IDCT block 140 and transformed. The output from the IDCT is then combined with the output of motion compensation block 150 by the adder 170. The motion compensation block 150 may reconstruct individual pictures based upon the changes from one picture to its reference picture(s). Data from the reference picture(s), a previous one or a future one or both, may be stored in a temporary frame memory block 160 such as a frame buffer and may be used as the references. The motion compensation block 150 uses the motion vectors decoded from the VLD 110 to determine how the current picture in the sequence changes from the reference picture(s). The output of the motion compensation block 150 is the motion prediction data. The motion prediction data is added to the output of the IDCT 140 by the adder 170. The output from the adder 170 is then clipped (not shown) to become the reconstructed video data.

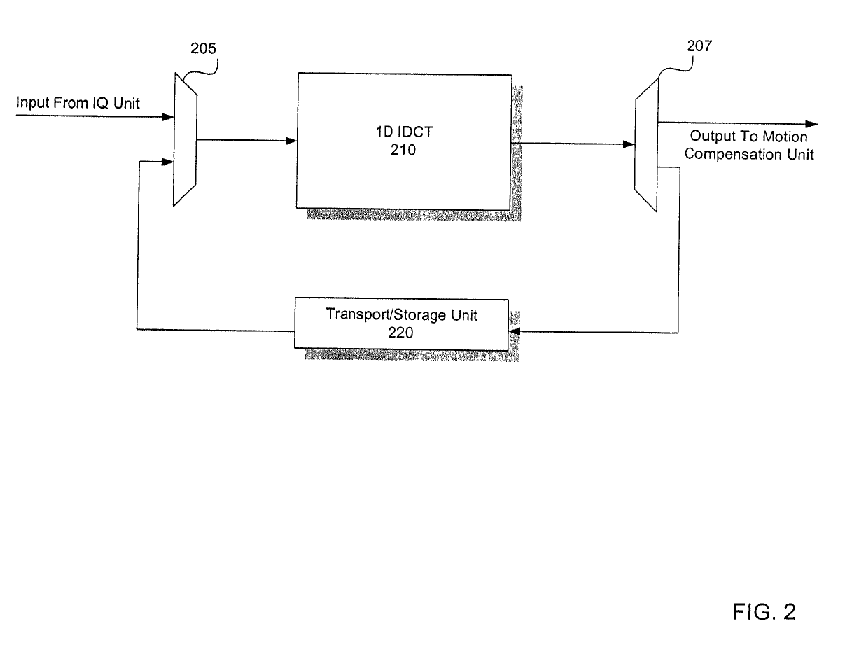

FIG. 2 is a block diagram of a datapath for computing a 2-dimensional (2D) IDCT according to one embodiment of the present invention. It includes a data multiplexer 205, a 1D IDCT block 210, a data demultiplexer 207 and a transport storage unit 220. Incoming data from IQ is processed in two passes through the IDCT. In the first pass, the IDCT block is configured to perform a ID IDCT transform along vertical direction. In this pass, data from IQ is selected by the multiplexer 210, processed by the ID IDCT block 210. The output from IDCT block 210 is an intermediate results that are selected by the demultiplexer to be stored in the transport storage unit 220. In the second pass, IDCT block 210 is configured to perform ID IDCT along horizontal direction. As such, the intermediate data stored in the transport storage unit 220 is selected by multiplexer 205, and processed by the ID IDCT block 210. Demultiplexer 207 outputs results from the ID IDCT block as the final result of the 2D IDCT.

Many computational processes such as the transforms described above (i.e., DCT, IDCT, DFT, etc) and filtering operations rely upon a multiply and accumulate kernel. That is, the algorithms are effectively performed utilizing one or more multiply and accumulate components typically implemented as specialized hardware on a DSP or other computer chip. The commonality of the MAC nature of these processes has resulted in the development of particular digital logic and circuit structures to carry out multiply and accumulate processes. In particular, a fundamental component of any DSP chip today is the MAC unit.

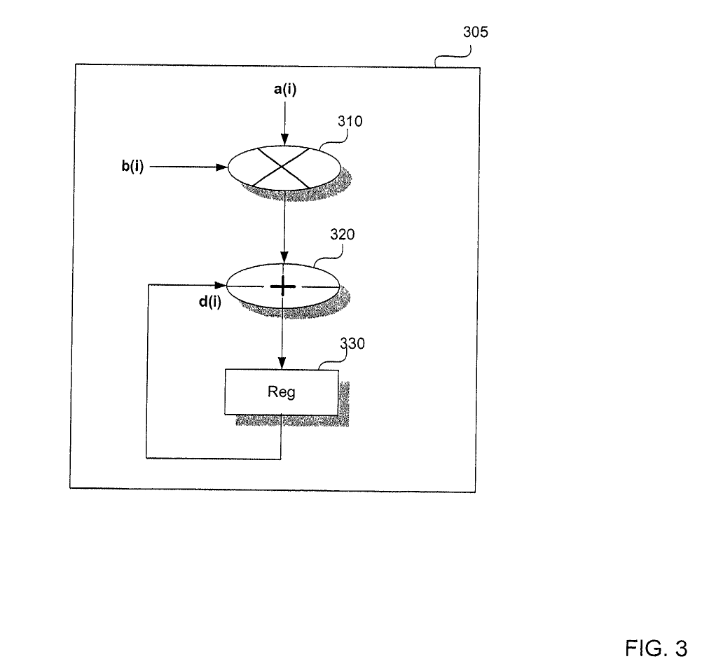

FIG. 3 is a block diagram illustrating the operation of a MAC kernel. Multiplier 310 performs multiplication of input datum a(i) and filter coefficient b(i), the result of which is passed to adder 320. Adder 320 adds the result of multiplier 310 to accumulated output d^{[1]} which was previously stored in register 330. The output of adder 320 (d^{[i+1]}) is then stored in register 330. Typically a MAC output is generated on each clock cycle.

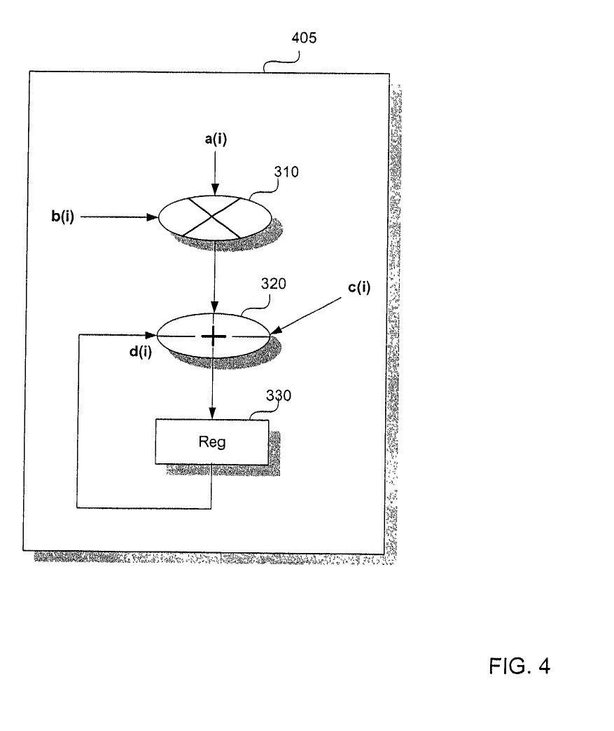

FIG. 4 is a block diagram illustrating the operation of a MAAC kernel according to one embodiment of the present invention. The MAAC kernel can be described by the following recursive equation:

d^{[i+1]}=d^{[i]}+a(i)*b(i)+c(i) with initial value d^{[0]}=0.

MAAC kernel 405 includes multiplier 310, adder 320 and register 330. Multiplier 310 performs multiplication of input datum a(i) and filter coefficient b(i), the result of which is passed to adder 320. Adder 320 adds the result of multiplier 310 to a second input term c(i) along with accumulated output d^{[1]}, which was previously stored in register 330. The output of adder 320 (d^{[i+1]}) is then stored in register 330.

As an additional addition (c(i)) is performed each cycle, the MAAC kernel will have higher performance throughput for some class of computations. For example, the throughput of a digital filter with some filter coefficients equal to one can be improved utilizing the MAAC architecture depicted in FIG. 4.

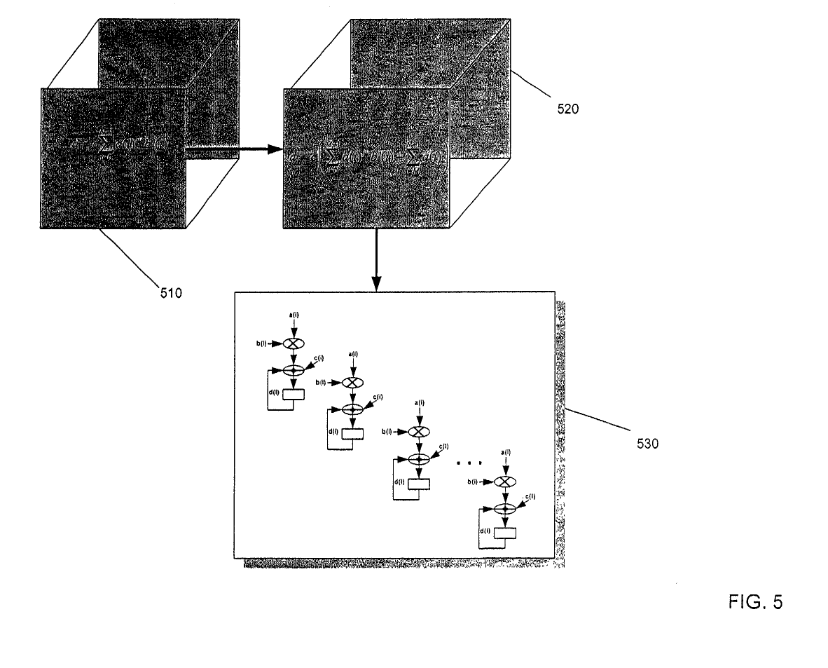

FIG. 5 illustrates a paradigm for improving computational processes utilizing a MAAC kernel according to one embodiment of the present invention. In 510, an expression for a particular computation is determined. Typically, the computation is expressed as a linear combination of input elements a(i) scaled by a respective coefficient b(i). That is, the present invention provides for improved efficiency of performance for computational problems that may be expressed in the general form:

$$d = {\sum }_{i = 0}^{N - 1} a ( i ) * b ( i )$$

where a(i) are the input data, b(i) are coefficients and d is the output. As noted above, utilizing a traditional MAC architecture, output d may be computed utilizing a kernel of the form:

d^{[i+1]}=d^{[i]}+a(i)*b(i) with initial value d^{[0]}=0.

This type of computation occurs very frequently in many applications including digital signal processing, digital filtering etc.

In 520, a common factor ‘c’ is factored out of the expression obtaining the following expression:

$$d = c {\sum }_{i = 0}^{N - 1} a ( i ) * {b}^{′} ( i ) where b ( i ) = {cb}^{′} ( i ) .$$

If as a result of factoring the common factor c, some of the coefficients b′(i) are unity, then the following result is obtained.

$$d = c ( {\sum }_{i = 0}^{M - 1} a ( i ) * {b}^{′} ( i ) + {\sum }_{i = M}^{N - 1} a ( i ) ) where \{ {b}^{′} ( i ) = 1 : M \leq i \leq N - 1 \}$$

This may be effected, for example, by factoring a matrix expression such that certain matrix entries are ‘1’. The above expression lends itself to use of the MAAC kernel described above by the recursive equation:

d^{[i+1]}=d^{[i]}+a(i)*b(i)+c(i) with initial value d^{[0]}=0.

In this form the computation utilizes at least one addition per cycle due to the unity coefficients.

In step 530, based upon the re-expression of the computational process accomplished in step 510, one or more MAAC kernels are arranged in a configuration to carry out the computational process as represented in its re-expressed form of step 520.

The paradigm depicted in FIG. 5 is particularly useful for multiply and accumulate computational processes. According to one embodiment, described herein, the method of the present invention is applied to provide a more efficient IDCT computation, which is a multiply and accumulate process typically carried out using a plurality of MAC kernels.

According to one embodiment, the present invention is applied to the IDCT in order to reduce computational complexity and improve efficiency. According to the present invention, the number of clock cycles required in a particular hardware implementation to carry out the IDCT is reduced significantly by application of the present invention.

The 2-D DCT may be expressed as follows:

$${y}_{kl} = \sqrt{\frac{2}{M}} a ( k ) \sqrt{\frac{2}{N}} a ( l ) {\sum }_{i = 0}^{M - 1} {\sum }_{j = 0}^{N - 1} {x}_{ij} cos ( \frac{( 2 i + 1 ) k π}{2 M} ) cos ( \frac{( 2 j + 1 ) l π}{2 N} )$$

$$where a ( k ) = \{ \begin{matrix}\frac{1}{\sqrt{2}} , if k = 0 \\ 1 otherwise\end{matrix} \}$$

The 2-D IDCT may be expressed as follows:

$${x}_{ij} = {\sum }_{k = 0}^{M - 1} {\sum }_{l = 0}^{N - 1} {y}_{kl} \sqrt{\frac{2}{M}} a ( k ) \sqrt{\frac{2}{N}} a ( l ) cos ( \frac{( 2 i + 1 ) k π}{2 M} ) cos ( \frac{( 2 j + 1 ) l π}{2 N} )$$

$$where a ( k ) = \{ \begin{matrix}\frac{1}{\sqrt{2}} , if k = 0 \\ 1 otherwise\end{matrix} \}$$

The 2-D DCT and IDCT are separable and may be factored as follows:

$${x}_{ij} = {\sum }_{k = 0}^{M - 1} {z}_{kj} {e}_{i , M} ( k ) for i = 0 , 1 , … , M - 1 \\ and j = 0 , 1 , … , N - 1$$

where the temporal 1-D IDCT data are:

$${z}_{kj} = {\sum }_{l = 0}^{N - 1} {y}_{kl} {e}_{j , N} ( l ) for k = 0 , 1 , … , M - 1$$

$$and j = 0 , 1 , … , N - 1$$

and the DCT basis vectors eᵢ(m) are:

$${e}_{1 , M} ( k ) = \sqrt{\frac{2}{M}} a ( k ) cos ( \frac{( 2 i + 1 ) l π}{2 M} ) for i , k = 0 , 1 , … , M - 1$$

A fast algorithm for calculating the IDCT (Chen) capitalizes of the cyclic property of the transform basis function (the cosine function). For example, for an eight point IDCT, the basis function only assumes 8 different positive and negative values as shown in the following table:

| j/l | 0 | 1 | 2 | 3 | 4 | 5 | 6 | 7 |
|---|---|---|---|---|---|---|---|---|
| 0 | c(0) | c(1) | c(2) | c(3) | c(4) | c(5) | c(6) | c(7) |
| 1 | c(0) | c(3) | c(6) | −c(7) | −c(4) | −c(1) | −c(2) | −c(5) |
| 2 | c(0) | c(5) | −c(6) | −c(1) | −c(4) | c(7) | c(2) | c(3) |
| 3 | c(0) | c(7) | −c(2) | −c(5) | c(4) | c(3) | −c(6) | −c(1) |
| 4 | c(0) | −c(7) | −c(2) | c(5) | c(4) | −c(3) | −c(6) | c(1) |
| 5 | c(0) | −c(5) | −c(6) | c(1) | −c(4) | −c(7) | c(2) | −c(3) |
| 6 | c(0) | −c(3) | c(6) | c(7) | −c(4) | c(1) | −c(2) | c(5) |
| 7 | c(0) | −c(1) | c(2) | −c(3) | c(4) | −c(5) | c(6) | −c(7) |

Where c(m) is the index of the following basis terms.

$$\begin{matrix}c ( m ) = a ( m ) cos ( \frac{m π}{16} ) \\ = \{ cos ( \frac{π}{4} ) , cos ( \frac{π}{16} ) , cos ( \frac{π}{8} ) , cos ( \frac{3 π}{16} ) , \\ cos ( \frac{π}{4} ) , cos ( \frac{5 π}{16} ) , cos ( \frac{3 π}{8} ) , cos ( \frac{7 π}{16} ) \} \\ = \{ cos ( \frac{π}{4} ) , cos ( \frac{π}{16} ) , cos ( \frac{π}{8} ) , cos ( \frac{3 π}{16} ) , \\ cos ( \frac{π}{4} ) , sin ( \frac{3 π}{16} ) , sin ( \frac{π}{8} ) , sin ( \frac{π}{16} ) \}\end{matrix}$$

The cyclical nature of the IDCT shown in the above table provides the following relationship between output terms of the 1-D IDCT:

$$\begin{matrix}\frac{{x}_{i} + {x}_{7 - i}}{2} = {e}_{i} ( 0 ) {y}_{o} + {e}_{i} ( 2 ) {y}_{2} + {e}_{i} ( 4 ) {y}_{4} + {e}_{i} ( 6 ) {y}_{6} \\ \frac{{x}_{i} + {x}_{7 - i}}{2} = {e}_{i} ( 1 ) {y}_{1} + {e}_{i} ( 3 ) {y}_{3} + {e}_{i} ( 5 ) {y}_{5} + {e}_{i} ( 7 ) {y}_{7}\end{matrix}$$

where the basis terms eᵢ(k) have sign and value mapped to the DCT basis terms c(m) according to the relationship:

$${e}_{i} ( k ) = \pm \frac{1}{2} c ( m ( i , k ) )$$

For a 4-point IDCT, the basis terms also have the symmetrical property illustrated in the above table as follows:

| j/1 | 0 | 1 | 2 | 3 |
|---|---|---|---|---|
| 0 | C(0) | C(2) | C(4) | C(6) |
| 1 | C(0) | C(6) | −C(4) | −C(2) |
| 2 | C(0) | −C(6) | −C(4) | C(2) |
| 3 | C(0) | −C(2) | C(4) | −C(6) |

The corresponding equations are:

$$\begin{matrix}\frac{{x}_{i} + {x}_{3 - i}}{2} = {e}_{i} ( 0 ) {y}_{0} + {e}_{i} ( 4 ) {y}_{2} \\ \frac{{x}_{i} - {x}_{3 - i}}{2} = {e}_{i} ( 2 ) {y}_{1} + {e}_{i} ( 6 ) {y}_{3}\end{matrix}$$

Based upon the above derivation, a ID 8-point IDCT can be represented by the following matrix vector equation:

$$\begin{matrix}[ \begin{matrix}{x}_{0} \\ {x}_{1} \\ {x}_{2} \\ {x}_{3}\end{matrix} ] = \frac{1}{2} A [ \begin{matrix}{y}_{0} \\ {y}_{4} \\ {y}_{2} \\ {y}_{6}\end{matrix} ] + \frac{1}{2} B [ \begin{matrix}{y}_{1} \\ {y}_{5} \\ {y}_{3} \\ {y}_{7}\end{matrix} ] \\ [ \begin{matrix}{x}_{7} \\ {x}_{6} \\ {x}_{5} \\ {x}_{4}\end{matrix} ] = \frac{1}{2} A [ \begin{matrix}{y}_{0} \\ {y}_{4} \\ {y}_{2} \\ {y}_{6}\end{matrix} ] - \frac{1}{2} B [ \begin{matrix}{y}_{1} \\ {y}_{5} \\ {y}_{3} \\ {y}_{7}\end{matrix} ] \\ where : \\ A = [ \begin{matrix}c ( 0 ) & c ( 4 ) & c ( 2 ) & c ( 6 ) \\ c ( 0 ) & - c ( 4 ) & c ( 6 ) & - c ( 2 ) \\ c ( 0 ) & - c ( 4 ) & - c ( 6 ) & c ( 2 ) \\ c ( 0 ) & c ( 4 ) & - c ( 2 ) & - c ( 6 )\end{matrix} ] \\ B = [ \begin{matrix}c ( 1 ) & c ( 5 ) & c ( 3 ) & c ( 7 ) \\ c ( 3 ) & - c ( 1 ) & - c ( 7 ) & - c ( 5 ) \\ c ( 5 ) & c ( 7 ) & - c ( 1 ) & c ( 3 ) \\ c ( 7 ) & c ( 3 ) & - c ( 5 ) & - c ( 1 )\end{matrix} ] \\ and c ( 0 ) = cos ( \frac{π}{4} ) and c ( n ) = cos ( \frac{n π}{16} ) ( n = 1 , 2 , 3 , 4 , 5 , 6 \; 7 ) \\ Note that {A}^{- 1} = \frac{1}{2} {A}^{T} and {B}^{- 1} = \frac{1}{2} {B}^{T}\end{matrix}$$

Using the paradigm depicted in FIG. 5, a common factor may be factored from the matrix equation above such that certain coefficients are unity. The unity coefficients then allow for the introduction of a number of MAAC kernels in a computational architecture, thereby reducing the number of clock cycles required to carry out the IDCT. In particular, by factoring

$$c ( 0 ) = c ( 4 ) = \frac{1}{\sqrt{2}}$$

out from the matrix vector equation above, the following equation is obtained.

$$\begin{matrix}[ \begin{matrix}{x}_{0} \\ {x}_{1} \\ {x}_{2} \\ {x}_{3}\end{matrix} ] = \frac{1}{2} {A}^{′} [ \begin{matrix}{y}_{0} \\ {y}_{4} \\ {y}_{2} \\ {y}_{6}\end{matrix} ] + \frac{1}{2} {B}^{′} [ \begin{matrix}{y}_{1} \\ {y}_{5} \\ {y}_{3} \\ {y}_{7}\end{matrix} ] \\ [ \begin{matrix}{x}_{7} \\ {x}_{6} \\ {x}_{5} \\ {x}_{4}\end{matrix} ] = \frac{1}{2} {A}^{′} [ \begin{matrix}{y}_{0} \\ {y}_{4} \\ {y}_{2} \\ {y}_{6}\end{matrix} ] - \frac{1}{2} {B}^{′} [ \begin{matrix}{y}_{1} \\ {y}_{5} \\ {y}_{3} \\ {y}_{7}\end{matrix} ] \\ where : \\ {A}^{′} = [ \begin{matrix}1 & 1 & {c}^{′} ( 2 ) & {c}^{′} ( 6 ) \\ 1 & - 1 & {c}^{′} ( 6 ) & - {c}^{′} ( 2 ) \\ 1 & - 1 & - {c}^{′} ( 6 ) & {c}^{′} ( 2 ) \\ 1 & 1 & - {c}^{′} ( 2 ) & - {c}^{′} ( 6 )\end{matrix} ] \\ {B}^{′} = [ \begin{matrix}{c}^{′} ( 1 ) & {c}^{′} ( 5 ) & {c}^{′} ( 3 ) & {c}^{′} ( 7 ) \\ {c}^{′} ( 3 ) & - {c}^{′} ( 1 ) & - {c}^{′} ( 7 ) & - {c}^{′} ( 5 ) \\ {c}^{′} ( 5 ) & {c}^{′} ( 7 ) & - {c}^{′} ( 1 ) & {c}^{′} ( 3 ) \\ {c}^{′} ( 7 ) & {c}^{′} ( 3 ) & - {c}^{′} ( 5 ) & - {c}^{′} ( 1 )\end{matrix} ]\end{matrix}$$

Because the factor

$$\frac{1}{\sqrt{2}}$$

is factored out of the matrix vector equation, the results after two-dimensional operations would carry a scale factor of two. Dividing the final result by 2 after the two-dimensional computation would result in the correct transform.

Note that the expression for the IDCT derived above incorporates multiple instances of the generalized expression

$$d = {\sum }_{i = 0}^{N - 1} a ( i ) * b ( i )$$

re-expressed as

$$d = c ( {\sum }_{i = 0}^{M - 1} a ( i ) * {b}^{′} ( i ) + {\sum }_{i = M}^{N - 1} a ( i ) )$$

where {b′(i)=1:M≦i≦N−1} to which the present invention is addressed. This is a consequence of the nature of matrix multiplication and may be seen as follows (unpacking the matrix multiplication):

x₀=y₀+y₄+c′(2)*y₂+c′(6)*y₆+c′(1)*y₁+c′(5)*y₅+c′(3)*y₃+c′(7)*y₇

x₁=y₀−y₄+c′(6)*y₂−c′(2)*y₆+c′(3)*y₁−c′(1)*y₅−c′(7)*y₃−c′(5)*y₇

x₂=y₀−y₄−c′(6)*y₂+c′(2)*y₆+c′(5)*y₁−c′(7)*y₅−c′(1)*y₃+c′(3)*y₇

x₃=y₀+y₄−c′(2)*y₂−c′(6)*y₆+c′(7)*y₁+c′(3)*y₅−c′(5)*y₃−c′(1)*y₇

x₇=y₀+y₄+c′(2)*y₂+c′(6)*y₆−c′(1)*y₁−c′(5)*y₅−c′(3)*y₃−c′(7)*y₇

x₆=y₀−y₄+c′(6)*y₂−c′(2)*y₆−c′(3)*y₁+c′(1)*y₅+c′(7)*y₃+c′(5)*y₇

x₅=y₀−y₄−c′(6)*y₂+c′(2)*y₆−c′(5)*y₁+c′(7)*y₅+c′(1)*y₃−c′(3)*y₇

x₄=y₀+y₄−c′(2)*y₂−c′(6)*y₆−c′(7)*y₁−c′(3)*y₅+c′(5)*y₃+c′(1)*y₇

Note that the above expressions do not incorporate scale factors ½, which can be computed at the end of the calculation simply as a right bit-shift. Further, note that each output value for x includes a linear combination of all y terms in the column. In addition, some y terms are associated with a multiplication operation, while others are associated with an addition operation. In particular, y₀ and y₄ are associated with addition, while y₂, y₆, y₁, y₅, y₃ and y₇ are associated with a multiplication operation. The above noted observations suggest that partial results for all x terms in a column may be computed on the fly using a MAAC kernel as described above so long as one addition term and one multiplication term are available.

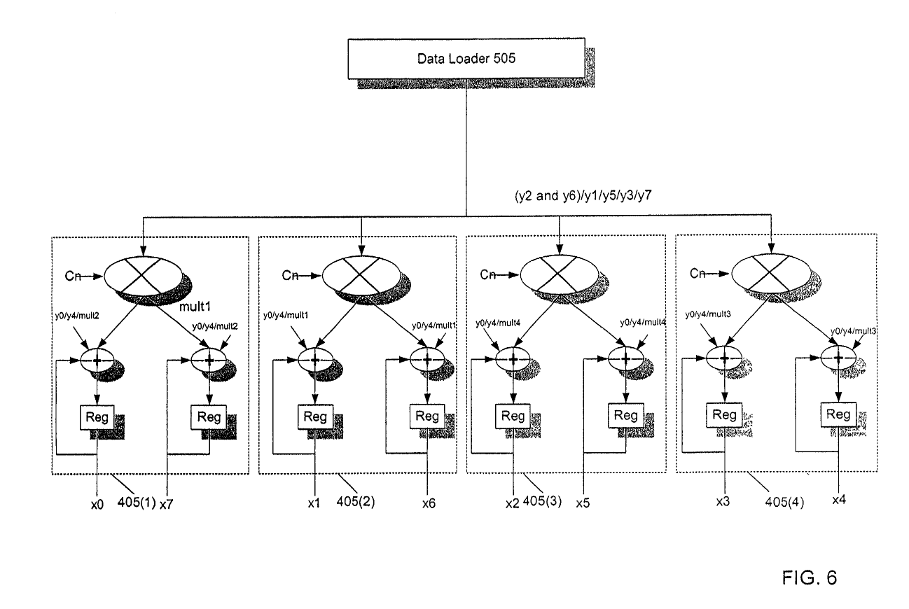

FIG. 6 is a block diagram of a hardware architecture for computing an eight point IDCT utilizing a MAAC kernel according to one embodiment of the present invention. The hardware architecture of FIG. 6 may be incorporated into a larger datapath for computation of an IDCT. As shown in FIG. 6, data loader 505 is coupled to four dual MAAC kernels 405(1)-405(4), each dual MAAC kernel including two MAAC kernels sharing a common multiplier. Note that the architecture depicted in FIG. 6 is merely illustrative and is not intended to limit the scope of the claims appended hereto. The operation of the hardware architecture depicted in FIG. 5 for computing the IDCT will become evident with respect to the following discussion.

Utilizing the architecture depicted in FIG. 6, a 1-D 8-point IDCT can be computed in 5 clock cycles as follows:

1^{st} Clock:

mult1=c′(1)*y₁

mult2=c′(3)*y₁

mult3=c′(5)*y₁

mult4=c′(7)*y₁

x₀(clk1)=y₀+mult1+0

x₇(clk1)=y₀−mult1+0

x₁(clk1)=y₀+mult2+0

x₆(clk1)=y₀−mult2+0

x₂(clk1)=y₀+mult3+0

x₅(clk1)=y₀−mult3+0

x₃(clk1)=y₀+mult4+0

x₄(clk1)=y₀−mult4+0

2^{nd} Clock:

mult1=c′(5)*y₅

mult2=−c′(1)*y₅

mult3=−c′(7)*y₅

mult4=c′(3)*y₅

x₀(clk2)=y₄+mult1+x₀(clk1)

x₇(clk2)=y₄−mult1+x₇(clk1)

x₁(clk2)=−y₄+mult2+x₁(clk1)

x₆(clk2)=−y₄−mult2+x₆(clk1)

x₂(clk2)=−y₄+mult3+x₂(clk1)

x₅(clk2)=−y₄−mult3+x₅(clk1)

x₃(clk2)=y₄+mult4+x₃(clk1)

x₄(clk2)=y₄−mult4+x₄(clk1)

3^{rd} Clock

mult1=c′(3)*y₃

mult2=−c′(7)*y₃

mult3=−c′(1)*y₃

mult4=−c′(5)*y₃

x₀(clk3)=0+mult1+x₀(clk2)

x₇(clk3)=0−mult1+x₇(clk2)

x₁(clk3)=0+mult2+x₁(clk2)

x₆(clk3)=0−mult2+x₆(clk2)

x₂(clk3)=0+mult3+x₂(clk2)

x₅(clk3)=0−mult3+x₆(clk2)

x₃(clk3)=0+mult4+x₃(clk2)

x₄(clk3)=0−mult4+x₄(clk2)

4^{th} Clock

mult1=c′(7)*y₇

mult2=−c′(5)*y₇

mult3=c′(3)*y₇

mult4=−c′(1)*y₇

x₀(clk4)=0+mult1+x₀(clk3)

x₇(clk4)=0−mult1+x₇(clk3)

x₁(clk4)=0+mult2+x₁(clk3)

x₆(clk4)=0−mult2+x₆(clk3)

x₂(clk4)=0+mult3+x₂(clk3)

x₅(clk4)=0−mult3+x₅(clk3)

x₃(clk4)=0+mult4+x₃(clk3)

x₄(clk4)=0−mult4+x₄(clk3)

5^{th} Clock

mult1=c′(2)*y₂

mult2=c′(6)*y₆

mult3=c′(6)*y₂

mult4=−c′(2)*y₆

x₀(clk5)=mult2+mult1+x₀(clk4)

x₇(clk5)=mult2+mult1+x₇(clk4)

x₁(clk5)=mult3+mult4+x₁(clk4)

x₆(clk5)=mult3+mult4+x₆(clk4)

x₂(clk5)=−mult3−mult4+x₂(clk4)

x₅(clk5)=−mult3−mult4+x₅(clk4)

x₃(clk5)=−mult1−mult2+x₃(clk4)

x₄(clk5)=−mult1−mult2+x₄(clk4)

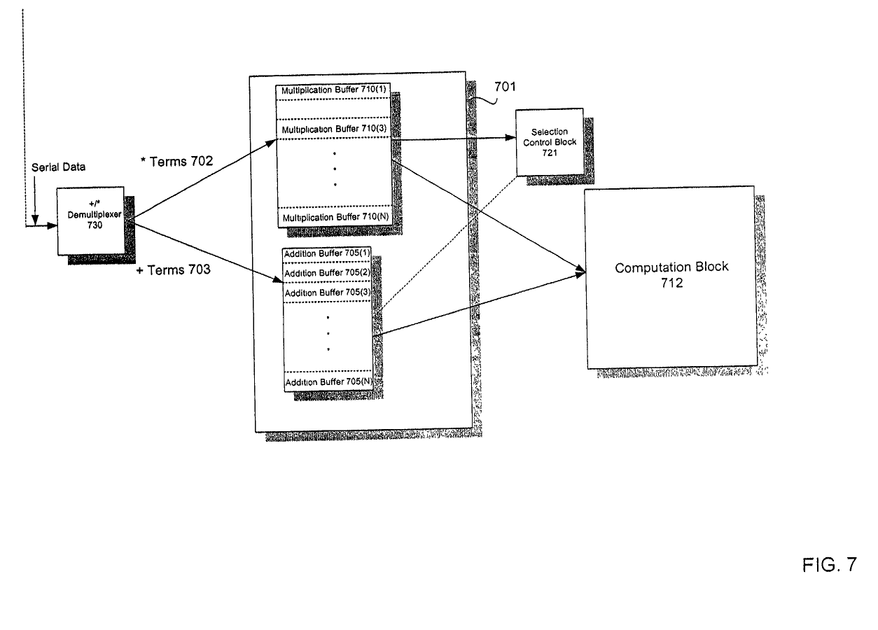

FIG. 7 is a block diagram illustrating a system for performing temporal order independent numerical computations on data. Temporal order independent numerical computation system 714 includes +/* demultiplexer 730, buffer block 701, selection control block 721 and computation block 712. Buffer block 701 includes a plurality of addition buffers 705(1)-705(N) and a plurality of multiplication buffers 710(1)-710(N). According to one embodiment of the present invention, addition buffers 705(1)-705(N) and multiplication buffers 710(1)-710(N) are FIFO (“First In First Out”) buffers.

As shown in FIG. 7, data arrives in serial fashion, where it is received at +/* demultiplexer 730. +/* demultiplexer 730 determines whether an arriving data value is associated with an addition or multiplication operation. If the data value is associated with an addition multiplication, +/* demultiplexer 730 sends the data value to one of addition buffers 705(1)-705(N). On the other hand, if the data value is associated with a multiplication operation, +/* demultiplexer sends the data value to one of multiplication buffers 710(1)-710(N). Data values stored in multiplication buffers 710(1)-710(N) are output to computation block. Based upon the nature of a particular multiplication value output from multiplication buffers 710(1)-710(N), data selection block causes addition buffers 705(1)-705(N) to output an associated data value stored in addition buffers 705(1)-705(N) associated with the multiplication data value.

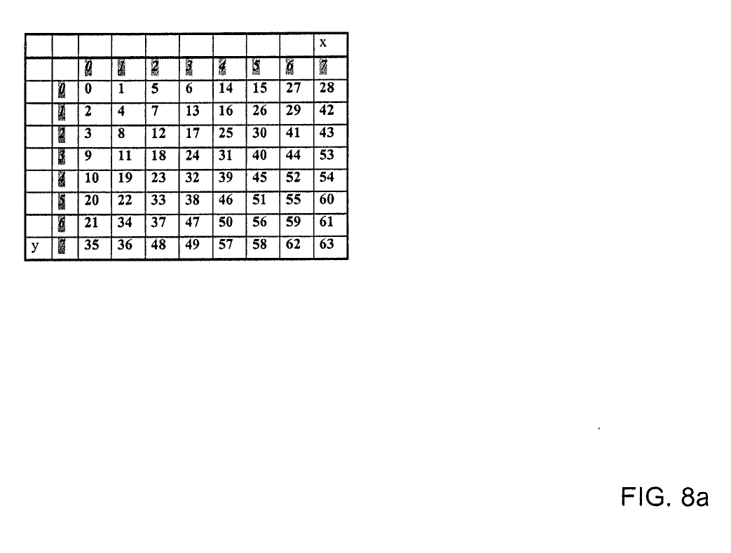

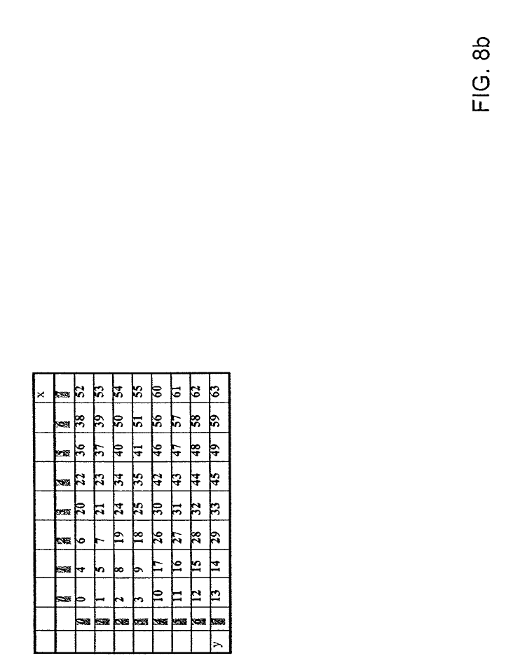

Typically 2-D DCT coefficient data arrives in either a zig-zag scan order or a horizontal scan order. FIG. 8a illustrates a zig-zag scan order for 2-D DCT coefficients. Note, for example, that the first column of DCT coefficients is not received until 35 coefficients have been received and stored. Thus, no IDCT operations can start until at least 35 coefficients have been stored even though only 8 coefficients are required. This creates significant processing bottlenecks and may introduce bubbles into a pipelined architecture. It would be greatly beneficial to be able to process the zig-zag ordered DCT data in a temporally independent manner.

FIG. 8b illustrates an alternate horizontal scan order for 2-D coefficients.

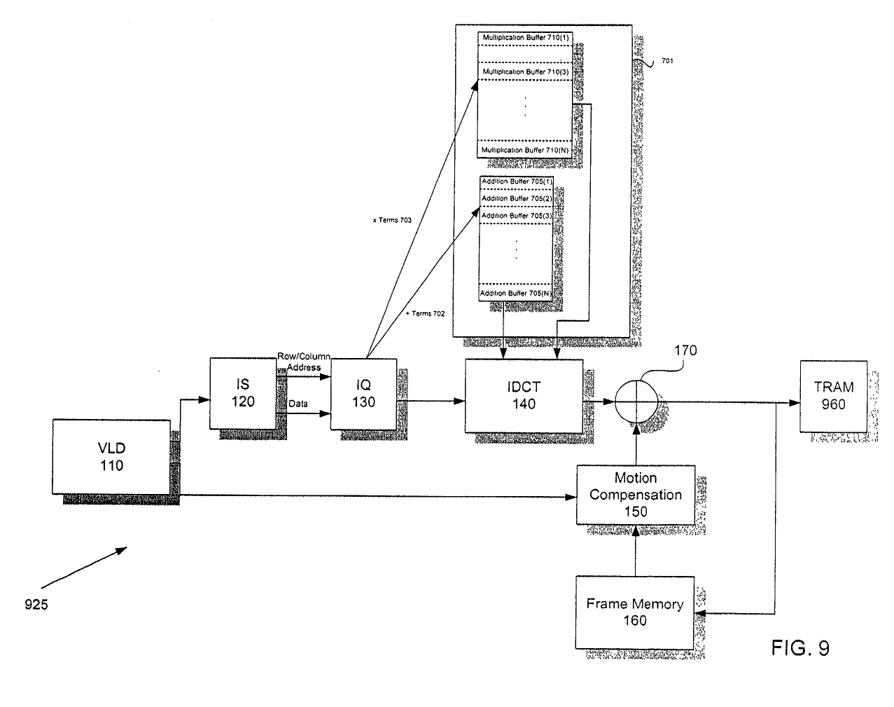

FIG. 9 is a block diagram of a system for temporal order independent computation of a 2-D IDCT according to one embodiment of the present invention. Temporal order independent IDCT system 825 includes VLD block 110, IS block 120, IQ block 130, IDCT block 140, frame memory block 160, temporary random access memory (“TRAM”) block 905, motion compensation block 150, adder 170 and buffer block 701. A compressed video bitstream is received by VLD block 110 and decoded. Note that the received bitstream will typically arrive in a zig-zag order. The decoded symbols are converted into quantized indices of DCT coefficients and their associated sequential locations in a particular scanning order. The sequential locations are then converted into frequency-domain locations by the IS block 120. The quantized indices of DCT coefficients are converted to DCT coefficients by the IQ block 130. The DCT coefficients are transferred to buffer block 701.

If the arriving coefficient is associated with a multiply operation, it is stored in one of multiply buffers 710(1)-710(N) along with its row column address generated by IS block 120. If the arriving coefficient is associated with an addition operation, it is stored in one of addition buffers 705(1)-705(N). In particular, according to one embodiment, the number of addition buffers corresponds directly to the number of rows/columns in the block. In particular, if a horizontal 1-D IDCT is being performed, the addition data value is stored in the nth addition buffer 705(1)-705(N), where n is the row address associated with the data value. Similarly, if a vertical 1-D IDCT is being performed, the addition data value is stored in the nth addition buffer 705(1)-705(N), where n is the column address associated with the data value. According to one embodiment for computing an 8-point IDCT, for example, one multiply buffer 710 is provided of depth 10 and 8 addition buffers 705(1)-705(8) are provided of depth 2. The 8 addition buffers correspond directly to the 8 columns of the DCT/IDCT.

The DCT coefficients are received by IDCT block 140 in the following manner. First a coefficient is read from one of the multiply buffers 710(1)-710(N). An addition coefficient is then read from one of the addition buffers 705(1)-705(N) that is associated with the multiply value. In particular, the row/column address of the multiply value is determined (as this information is stored in multiply buffers 710(1)-710(N)) and based upon the column address of the multiply value, the next addition value from the nth addition buffer 705(1)-705(N) is read and passed to IDCT block 140.

Utilizing the addition and multiply values, IDCT block computes a partial result based upon the underlying equations for the IDCT calculation and adds this partial result to the result stored in TRAM 960.

The output from the IDCT is then combined with the output of motion compensation block 150 by the adder 170. The motion compensation block 150 may reconstruct individual pictures based upon the changes from one picture to its reference picture(s). Data from the reference picture(s), a previous one or a future one or both, may be stored in a temporary frame memory block 160 such as a frame buffer and may be used as the references. The motion compensation block 150 uses the motion vectors decoded from the VLD 110 to determine how the current picture in the sequence changes from the reference picture(s). The output of the motion compensation block 150 is the motion prediction data. The motion prediction data is added to the output of the IDCT 140 by the adder 170. The output from the adder 170 is then clipped (not shown) to become the reconstructed video data.

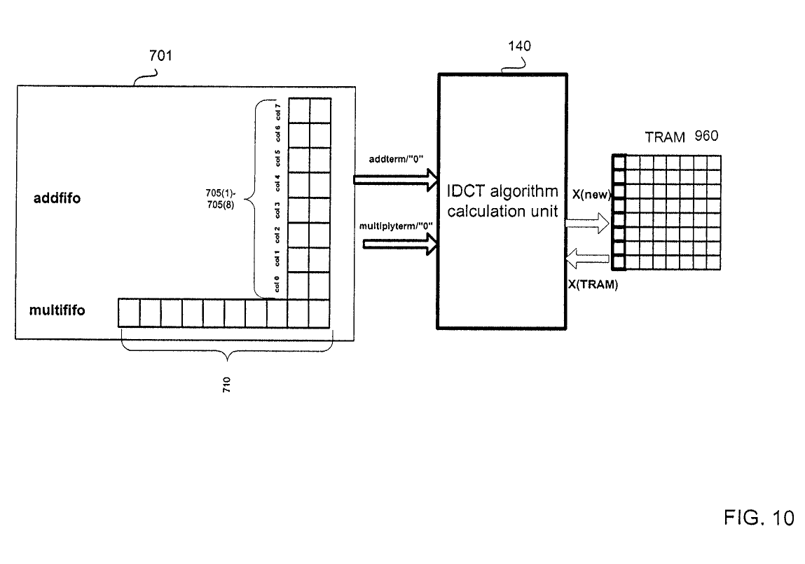

FIG. 10 illustrates a buffer block, IDCT computation unit and TRAM unit for computation of an eight-point IDCT according to one embodiment of the present invention. As shown in FIG. 10, addition terms and multiplication terms are received from buffer block 701 by IDCT computation unit 140, where they are processed. IDCT computation unit 140 makes use of TRAM 960 to store partial results during computation of the IDCT. According to one embodiment for computing an 8-point IDCT, one multiply buffer 710 is provided of depth 10 and 8 addition buffers 705(1)-705(8) are provided of depth 2. The 8 addition buffers correspond directly to the 8 columns of the DCT/IDCT.

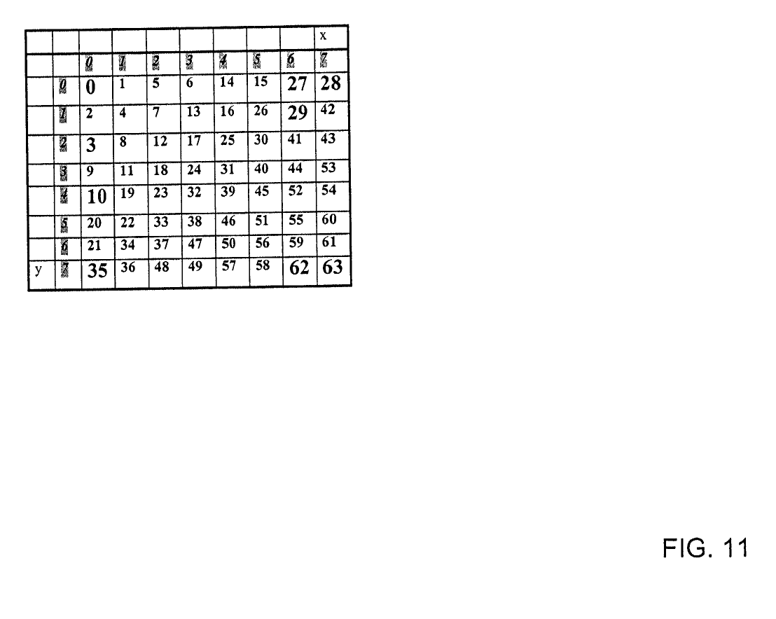

FIG. 11 illustrates illustrates a state of a buffer block, IDCT computation unit and TRAM unit for computation of an eight-point IDCT, wherein the DCT coefficients arrive in zig-zag scan order. As shown in FIG. 10, the only nonzero coefficients are depicted in the larger font type. Utilizing the denotation that (1,2) specifies a column address followed by a row address, the only nonzero coefficients in the block are (0,0), (0,2), (0,4), (6,0), (7,0), (6,1), (0,7), (6,7), and (7,7).

With this sequence of input data, the following computations are performed on each clock cycle:

1^{st} Clock(After IDCT Algorithm Calculation Unit is Free to Process This Block)

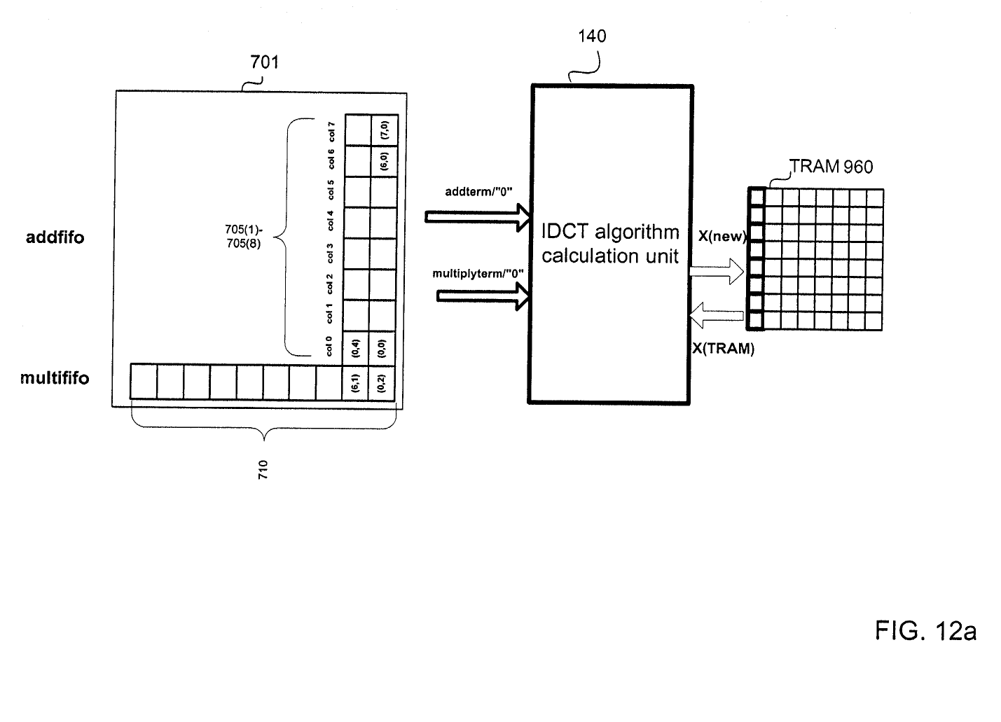

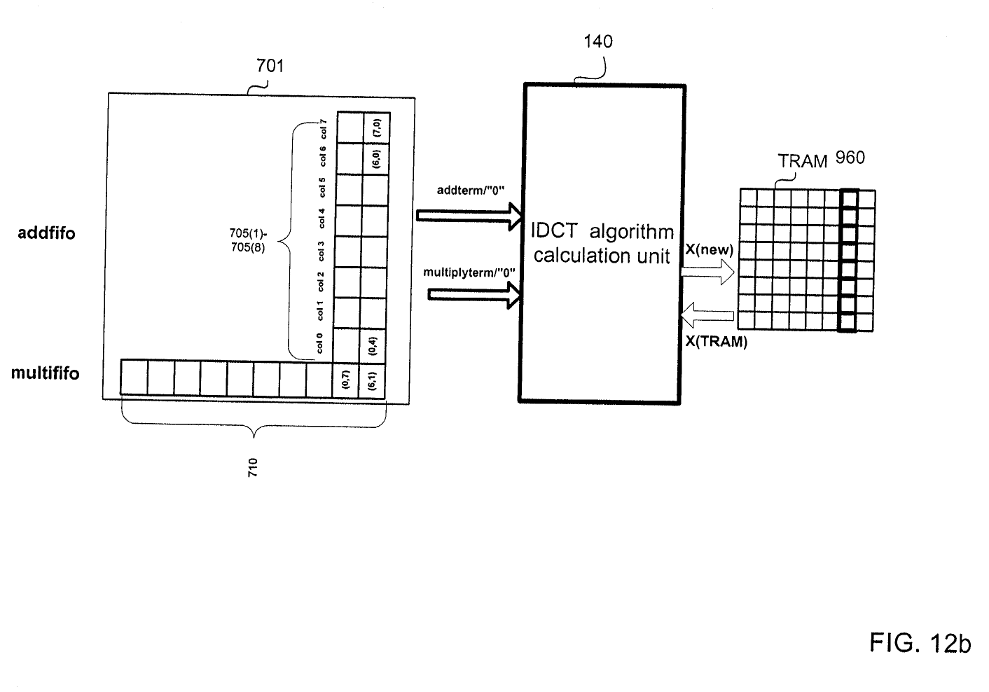

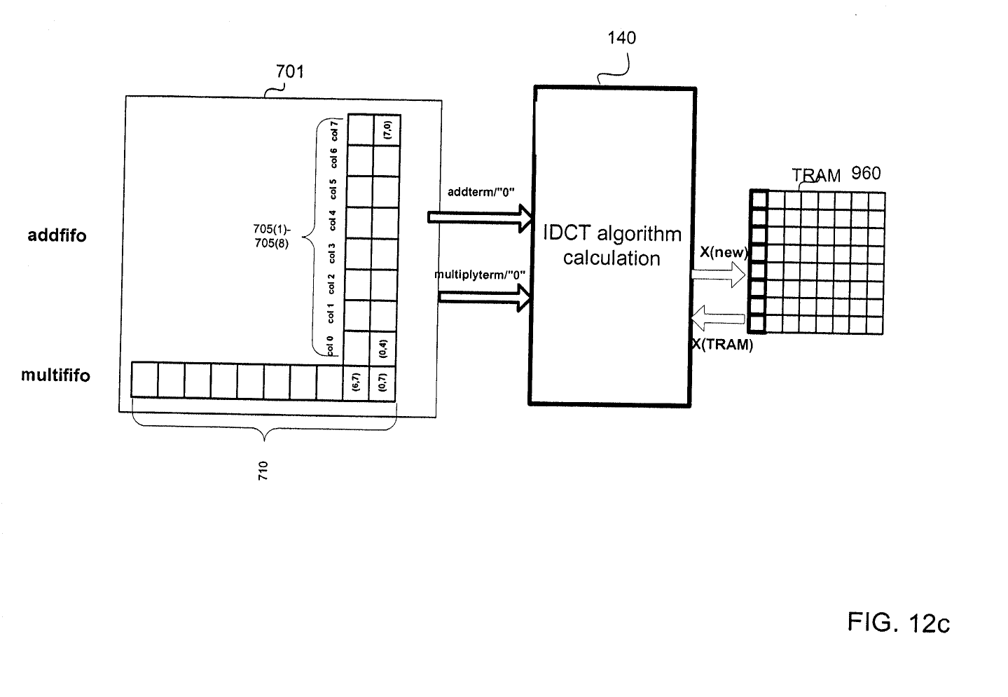

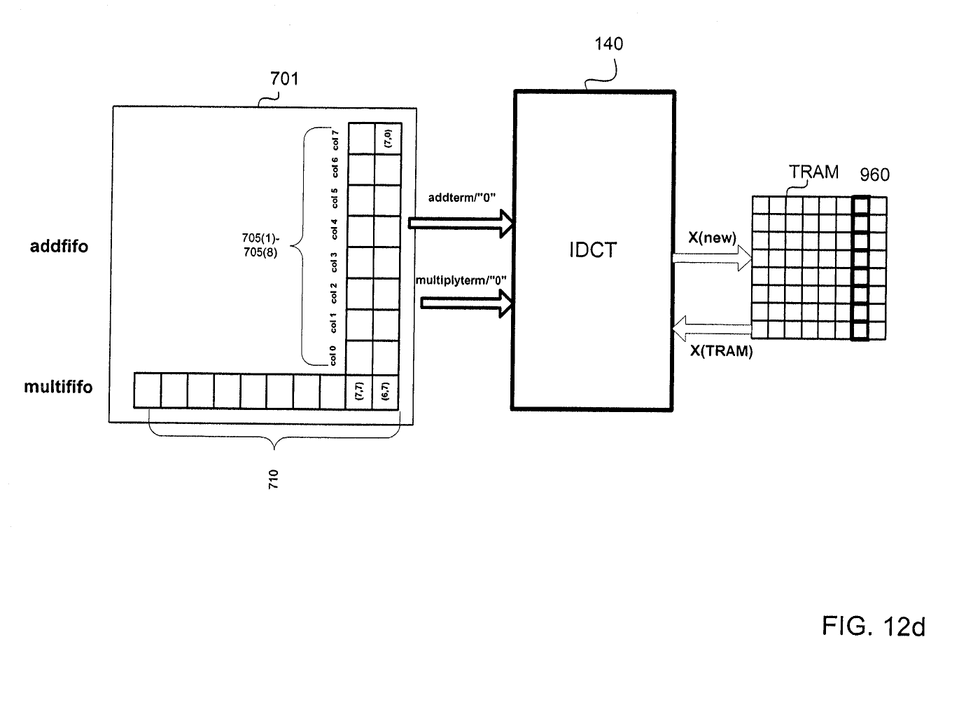

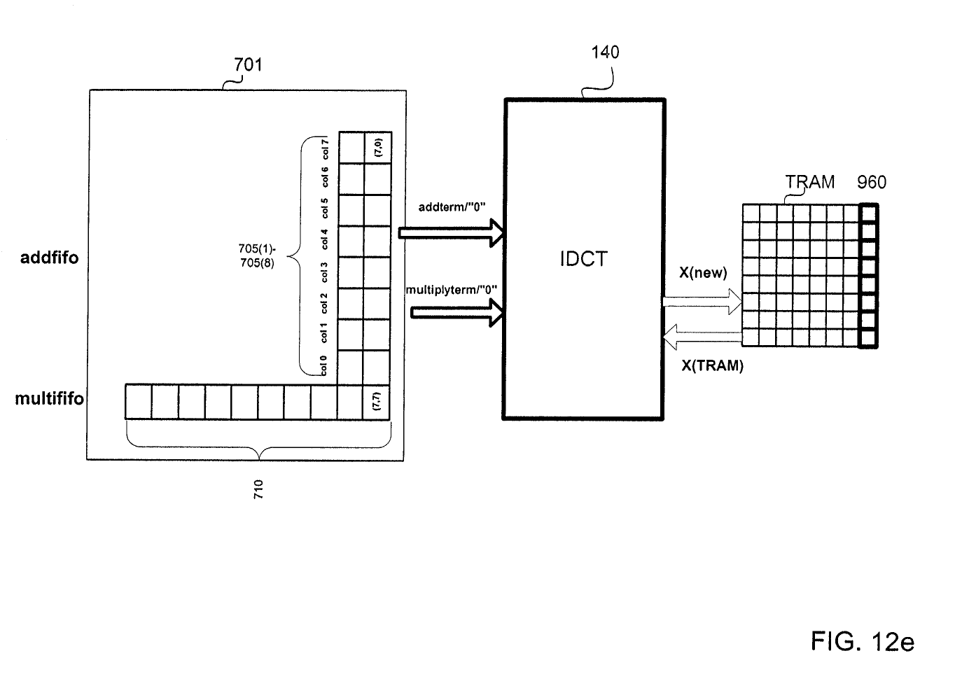

FIG. 12a illustrates a state of a buffer block with respect to an IDCT computation unit and TRAM during a first clock cycle according to one embodiment of the present invention. It is assumed, as shown in FIG. 12a, that coefficient terms (0,0), (0,2), (0,4), (6,0), (7,0), (6,1) and (0,4) have been buffered. On the 1^{st} clock all the values in the TRAM are initialized to “0” when IDCT algorithm calculation unit 140 is ready to process the new block. Next, addterm y(0,0) and multiterm y(0,2) will be sent to IDCT algorithm unit 140, and the following computations performed for column 0:

x(0,0)(new)=y(0,0)+c′(2)*y(0,2)+x(0,0)(from TRAM)

x(0,1)(new)=y(0,0)+c′(6)*y(0,2)+x(0,1)(from TRAM)

x(0,2)(new)=y(0,0)−c′(6)*y(0,2)+x(0,2)(from TRAM)

x(0,3)(new)=y(0,0)−c′(2)*y(0,2)+x(0,3)(from TRAM)

x(0,7)(new)=y(0,0)+c′(2)*y(0,2)+x(0,7) (from TRAM)

x(0,6)(new)=y(0,0)+c′(6)*y(0,2)+x(0,6) (from TRAM)

x(0,5)(new)=y(0,0)−c′(6)*y(0,2)+x(0,5) (from TRAM)

x(0,4)(new)=y(0,0)−c′(2)*y(0,2)+x(0,4) (from TRAM)

All computed coefficients for the first column x(0,0)(new)-x(0,7)(new) are then written to TRAM 960.

2nd Clock

FIG. 12b illustrates a state of a buffer block with respect to an IDCT computation unit and TRAM during a second clock cycle according to one embodiment of the present invention. As shown in FIG. 12b, coefficient terms (6,1), (0,4), (6,0), (7,0) and (0,7) are buffered as terms (0,0) and (0,2) were processed on the prior clock cycle. During the second clock cycle, multiterm y(6,1) and addterm y(6,0) are sent to IDCT algorithm unit 140 and computations are performed for the 6^{th} column and appropriately updated at TRAM 960 as follows:

x(6,0) (new)=y(6,0)+c′(1)*y(6,1)+x(6,0) (from TRAM)

x(6,1) (new)=y(6,0)+c′(3)*y(6,1)+x(6,1) (from TRAM)

x(6,2) (new)=y(6,0)+c′(5)*y(6,1)+x(6,2) (from TRAM)

x(6,3) (new)=y(6,0)+c′(7)*y(6,1)+x(6,3) (from TRAM)

x(6,7) (new)=y(6,0)−c′(1)*y(6,1)+x(6,7) (from TRAM)

x(6,6) (new)=y(6,0)−c′(3)*y(6,1)+x(6,6) (from TRAM)

x(6,5) (new)=y(6,0)−c′(5)*y(6,1)+x(6,5) (from TRAM)

x(6,4) (new)=y(6,0)−c′(7)*y(6,1)+x(6,4) (from TRAM)

Upon completion of these computations by IDCT unit 140, all the column 6 data x(6,0)(new)-x(6,4)(new) are written back TRAM 960

3rd Clock

FIG. 12c illustrates a state of a buffer block with respect to an IDCT computation unit and TRAM during a third clock cycle according to one embodiment of the present invention. As shown in FIG. 12c, coefficient terms (0,7), (0,4), (7,0), and (6,7) are buffered as terms (6,0) and (6,1) were processed on the prior clock cycle. During the third clock cycle, multiterm y(0,7) and addterm y(0,4) are sent to IDCT arithmetic unit 140 and the following computations performed:

x(0,0)(new)=y(0,4)+c′(7)*y(0,7)+x(0,0)(from TRAM)

x(0,1)(new)=−y(0,4)−c′(5)*y(0,7)+x(0,1)(from TRAM)

x(0,2)(new)=−y(0,4)+c′(3)*y(0,7)+x(0,2)(from TRAM)

x(0,3)(new)=y(0,4)−c′(1)*y(0,7)+x(0,3)(from TRAM

x(0,7)(new)=y(0,4)−c′(7)*y(0,7)+x(0,7)(from TRAM)

x(0,6)(new)=−y(0,4)+c′(5)*y(0,7)+x(0,6)(from TRAM)

x(0,5)(new)=−y(0,4)−c′(3)*y(0,7)+x(0,5)(from TRAM)

x(0,4)(new)=y(0,4)+c′(1)* y(0,7)+x(0,4)(from TRAM)

Upon completion of these computations by IDCT unit 140, all the column 0 data x(0,0)(new)-x(0,7)(new) are written back TRAM 960.

4th Clock

FIG. 12d illustrates a state of a buffer block with respect to an IDCT computation unit and TRAM during a fourth clock cycle according to one embodiment of the present invention. As shown in FIG. 12d, coefficient terms (6,7), (7,0) and (7,7) are buffered as terms (0,7) and (0,4) were processed on the prior clock cycle. During the fourth clock cycle, multiterm y(6,7) is sent to IDCT arithmetic unit 140 and the following computations performed (note that no addition term is sent to IDCT computation unit 140 during this clock cycle as they are zero):

x(6,0)(new)=+c′(7)*y(6,7)+x(6,0)(from TRAM)

x(6,1)(new)=−c′(5)*y(6,7)+x(6,1)(from TRAM)

x(6,2)(new)=+c′(3)*y(6,7)+x(6,2)(from TRAM)

x(6,3)(new)=−c′(1)*y(6,7)+x(6,3)(from TRAM

x(6,7)(new)=−c′(7)*y(6,7)+x(6,7)(from TRAM)

x(6,6)(new)=+c′(5)*y(6,7)+x(6,6)(from TRAM)

x(6,5)(new)=−c′(3)*y(6,7)+x(6,5)(from TRAM)

x(6,4)(new)=+c′(1)*y(6,7)+x(6,4)(from TRAM)

Upon completion of these computations by IDCT unit 140, all the column 6 data x(6,0)(new)-x(6,7)(new) are written back TRAM 960.

5th Clock

FIG. 12e illustrates a state of a buffer block with respect to an IDCT computation unit and TRAM during a fifth clock cycle according to one embodiment of the present invention. As shown in FIG. 12e coefficient terms (7,7) are buffered as terms (6,7) was processed on the prior clock cycle. During the fifth clock cycle, multiterm y(7,7) and add term y(7,0) are sent to IDCT arithmetic unit 140 and the following computations performed:

x(7,0)(new)=y(7,0)+c′(7)*y(7,7)+x(7,0)(from TRAM)

x(7,1)(new)=y(7,0)−c′(5)*y(7,7)+x(7,1)(from TRAM)

x(7,2)(new)=y(7,0)+c′(3)*y(7,7)+x(7,2)(from TRAM)

x(7,3)(new)=y(7,0)−c′(1)*y(7,7)+x(7,3)(from TRAM

x(7,7)(new)=y(7,0)−c′(7)*y(7,7)+x(7,7)(from TRAM)

x(7,6)(new)=y(7,0)+c′(5)*y(7,7)+x(7,6)(from TRAM)

x(7,5)(new)=y(7,0)−c′(3)*y(7,7)+x(7,5)(from TRAM)

x(7,4)(new)=y(7,0)+c′(3)*y(7,7)+x(7,4)(from TRAM)

Upon completion of these computations by IDCT unit 140, all the column 7 data x(7,0)(new)-x(7,7)(new) are written back TRAM 960.

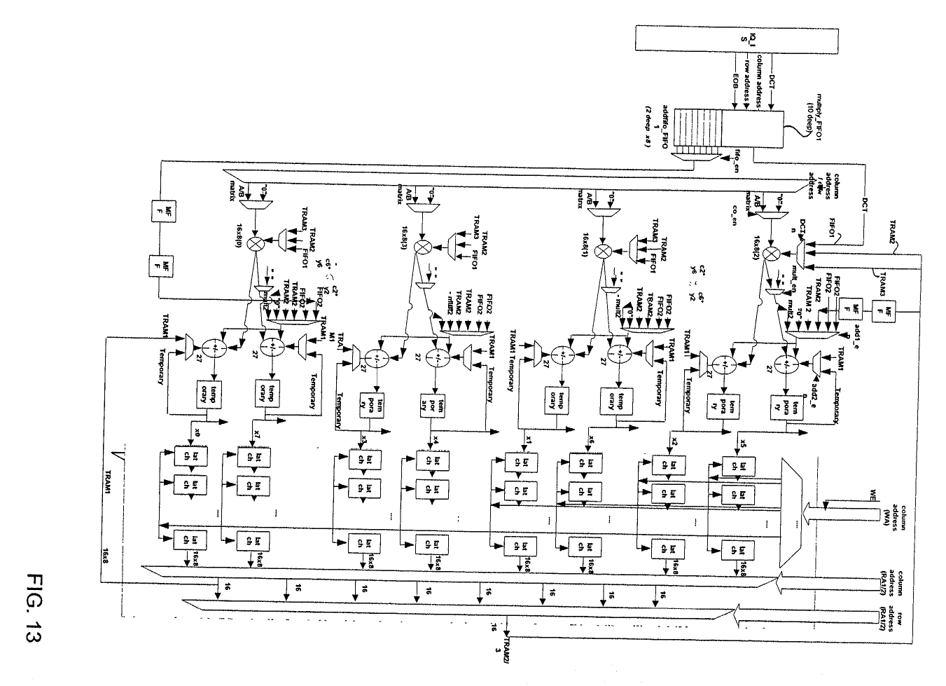

FIG. 13 illustrates a hardware embodiment for computing an 8-point IDCT according to one embodiment of the present invention.

What is claimed is:

1. A system for performing temporal order independent numerical computations on data comprising:
a computation block;
a buffer block, wherein the buffer block includes at least one first buffer for storing data values utilized in an addition operation by the computation block and at least one second buffer for storing data values utilized in a multiplication operation by the computation block;
wherein, upon a condition, data values are transferred from the buffer block to the computation block for processing.

2. The system according to claim 1, wherein the first and second buffers are FIFO (“First In First Out”) buffers.

3. The system according to claim 2, wherein the computation block computes an IDCT (“Inverse Discrete Cosine Transform”).

4. The system according to claim 3, wherein eight first buffers are utilized, each corresponding to a column of an 8×8 block of data.

5. The system according to claim 3, wherein the IDCT is a 2-D IDCT.

6. The system according to claim 1, further including a temporary random access memory (“TRAM”) block, wherein the TRAM block stores partial results of the computation between clock cycles.

7. The system according to claim 6, wherein upon the condition, a partial result is transferred from the TRAM to the computation block.

8. The system according to claim 7, wherein the computation block generates a new partial result utilizing data values transferred from the buffer block and the partial result transferred from the TRAM, the new partial result being then stored back in the TRAM.

9. A system for performing temporal order independent numerical computations on data comprising:
a computation block;
a buffer block, wherein the buffer block includes at least one first buffer for storing data values utilized in an addition operation by the computation block and at least one second buffer for storing data values utilized in a multiplication operation by the computation block;
a TRAM block, wherein the TRAM block stores partial results of the computation between clock cycles;
wherein, upon an occurrence of a predetermined condition, data values are transferred from the buffer block and the TRAM block to the computation block for processing.

10. The system according to claim 9, wherein the computation block computes an IDCT (“Inverse Discrete Cosine Transform”).

11. The system according to claim 9, wherein eight first buffers are utilized, each corresponding to a column of an 8×8 block of data.

12. The system according to claim 9, wherein the computation block computes an IDCT (“Inverse Discrete Cosine Transform”).

13. The system according to claim 9, wherein the IDCT is a 2-D IDCT.

14. A method for performing temporal order independent computations comprising:
receiving a data value for processing;
determining whether the data value corresponds to one of an addition operation and a multiplication operation;
if the data value corresponds to a multiplication operation, storing the data value in a multiplication buffer;
if the data value corresponds to an addition operation, storing the data value in an addition buffer; and
outputting a data value stored in the multiplication buffer and an associated data value stored in the addition buffer to a computation block for processing.

15. The method according to claim 14, further comprising storing partial results generated by the computation block in a TRAM.
